(19) United States
(12) Patent Application Publication
(10) Pub. No.: US 2013/0248602 A1
(43) Pub. Date: Sep. 26, 2013

(54) APPARATUS FOR AND METHOD OF CONTROLLING IMAGING EXPOSURE OF TARGETS TO BE READ

(71) Applicants: Duanfeng HE, South Setauket, NY (US); Eugene JOSEPH, Coram, NY (US)

(72) Inventors: Duanfeng HE, South Setauket, NY (US); Eugene JOSEPH, Coram, NY (US)

(73) Assignee: Symbol Technologies, Inc., Holtsville, NY (US)

(21) Appl. No.: 13/425,855

(22) Filed: Mar. 21, 2012

(51) Int. Cl. G06K 7/14

(52) U.S. Cl. 235/455

(57) ABSTRACT

An apparatus and method for imaging targets, such as electronic codes displayed on screens or direct part marking codes marked on workpieces, include an illumination system for illuminating a target with illumination light directed through a window of a housing, a solid-state, exposable imager looking at a field of view that extends through the window to the target, and operative for capturing return illumination light from the field of view as an image, and a controller for processing the image to attempt reading the target. The controller identifies the target within the image, determines a brightness level of a background region or a region of interest when the target cannot be read or identified, exposes the imager for an exposure time based on the brightness level, and reads the target with the imager exposed for the exposure time.

### FIELD OF THE DISCLOSURE

The present disclosure relates generally to an apparatus for, and a method of, electro-optically reading targets by image capture and, more particularly, to adjusting an imaging exposure based on a level of brightness of a background region in which a target is located or a region of interest of a captured image.

### BACKGROUND

Solid-state imaging apparatus or imaging readers, that have been configured either as handheld, portable scanners; stand-mounted, stationary scanners; vertical slot scanners; flat-bed or horizontal slot scanners; or bi-optical, dual window scanners; have been used in many venues, such as supermarkets, department stores, and other kinds of retailers, libraries, parcel deliveries, as well as factories, warehouses and other kinds of industrial settings, for many years, in both handheld and hands-free modes of operation, to electro-optically read by image capture a plurality of symbol targets, such as one-dimensional symbols, particularly Universal Product Code (UPC) bar code symbols, and two-dimensional symbols, as well as non-symbol targets, such as driver's licenses, receipts, signatures, etc., the targets being associated with, or borne by, objects or products to be processed by the imaging readers. In the handheld mode, a user, such as an operator or a customer, held the imaging reader and manually aimed a window thereon at the target. In the hands-free mode, the user slid or swiped a product associated with, or bearing, the target in a moving direction across and past a window of the reader in a swipe mode, or momentarily presented the target associated with, or borne by, the product to an approximate central region of the window, and steadily momentarily held the target in front of the window, in a presentation mode. The choice depended on the type of the reader, or on the user's preference, or on the layout of the venue, or on the type of the product and target.

The imaging reader included a solid-state imager (also known as an imaging sensor) with a sensor array of photocells or light sensors (also known as pixels), which corresponded to image elements or pixels over a field of view of the imaging sensor, an illumination assembly including a plurality of illumination light sources for illuminating the field of view, and an imaging lens assembly for capturing return ambient and/or illumination light scattered and/or reflected from any item in the field of view, and for projecting the return light onto the imaging sensor to initiate capture of an image of substantially every item in the field of view. The field of view contained a target to be imaged over a working range of distances, as well as neighboring environmental items, as described below. A part of the image contained the target as target data. Another part of the image contained the neighboring environmental items as non-target data. The imaging sensor was configured as a one- or two-dimensional charge coupled device (CCD) or a complementary metal oxide semiconductor (CMOS) device, and included associated circuits for producing and processing an electrical signal corresponding to a one- or two-dimensional array of the data over the field of view. The imaging sensor was controlled by a controller or programmed microprocessor that was operative for processing the electrical signal into information indicative of the target being imaged and, when the target was a symbol, for processing, decoding and reading the symbol.

In direct part marking (DPM) applications in common usage in the automotive, aerospace, electronics, medical equipment, tooling, and metalworking industries, among many others, machine-readable targets, such as high-density, two-dimensional, matrix-type, optical codes, especially the DataMatrix or QR codes, were directly marked (imprinted, etched, or dot-peened) on workpieces, identified, and traced to their origin. However, when such DPM codes were attempted to be read by the above-described imaging readers, the DPM codes often exhibited a low and inconsistent imaging contrast relative to their neighboring environmental items. Such neighboring environmental items may have included, for example, parts of a hand of the operator holding the workpiece, or remote portions of the workpiece itself. Such workpiece portions may have been metal, plastic, leather, or glass, etc., often having complicated, i.e., non-planar, shapes, as well as highly reflective areas.

Targets exhibiting poor imaging contrast were also often found at places other than on DPM workpieces. For example, symbol targets and non-symbol targets have been displayed on screens, such as CRT or LCD displays, especially on cell phones, smartphones, tablets, or like electronic devices. By way of example, a consumer transaction may be performed using a cell phone where a consumer uses the cell phone to purchase a ticket, such as an event ticket or a lottery ticket, including making payment via the cell phone and receiving the purchased ticket as an electronic ticket through the cell phone in the form of a message bearing a bar code symbol that is displayed by the cell phone on its screen. Upon redemption of the ticket, the electronic ticket's bar code symbol displayed on the cell phone screen is scanned by a merchant's imaging reader when redeeming the ticket.

However, as advantageous as such displayed targets were, the reading of the displayed targets proved to be as challenging as for the DPM targets described above. The displayed targets also exhibited a low and inconsistent imaging contrast relative to their neighboring environmental items. Such neighboring environmental items may have included, for example, parts of a hand of the operator holding the electronic device, or remote portions of the electronic device itself. The display screen of the electronic device was highly reflective.

The part of the image containing the optical code or target, whether marked on a DPM workpiece, or displayed on a screen, often appeared washed-out as compared to the part of the image of its neighboring environmental items, which were often illuminated with intense, bright light as hot spots or areas, glare, or specular reflections due to such factors as variable ambient lighting conditions and variable illumination from the illumination light sources on-board the imaging reader. If the imaging reader had an auto-exposure control circuit, then such bright light areas adversely affected the imager exposure, because the auto-exposure control circuit considered and took the bright areas into account when setting the exposure. For example, if these bright areas on the neighboring environmental items were very intense, then the auto-exposure control circuit would set the exposure to be too high. As a result, the optical code or target was often generally indiscernible from its neighboring environmental items, thereby degrading reading performance.

Accordingly, it would be desirable to control the imaging exposure without substantially taking into account the return light from the neighboring environmental items, thereby enhancing the readability of targets that exhibit low contrast in certain applications, especially DPM codes on workpieces and displayed codes on electronic device screens.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a perspective view of a representative imaging reader configured as a vertical slot scanner in accordance with this invention.

FIG. 2 is a part-schematic, part-diagrammatic view depicting various components of the reader of FIG. 1.

FIG. 3 is a front view of a representative mobile device displaying an electronic code to be imaged by the reader of FIGS. 1-2.

FIG. 4 is a front perspective view of a representative workpiece displaying a DPM optical code to be imaged by the reader of FIGS. 1-2.

FIG. 5 is a flow chart depicting operation of some of the components of the reader of FIGS. 1-2 in accordance with this invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

An apparatus, in accordance with one feature of this invention, is operative for imaging optical targets. The optical targets are advantageously, but not necessarily, displayed on a screen of an electronic device, or are marked on a DPM workpiece. The apparatus comprises a housing and a window supported by the housing and facing the optical target in use. The housing and window can be configured as a handheld, portable scanner, a stand-mounted, stationary scanner, a vertical slot scanner, a flat-bed or horizontal slot scanner, a bi-optical, dual window scanner, or like scanners. The apparatus further comprises an energizable illumination system supported by the housing and operative for illuminating the optical target with illumination light directed through the window, a solid-state, exposable imager supported by the housing and having an array of light sensors looking at a field of view that extends through the window to the illuminated target, and operative for capturing return illumination light from the field of view as an image, and a controller operatively connected to the imager and the illumination system, and operative for processing the image to attempt reading the illuminated target.

The controller is further operative for identifying the illuminated target within the image, for determining a target brightness level of a background region in which at least a part of the illuminated target is located when the illuminated target cannot be read, for exposing the imager for an exposure time based on the determined target brightness level, and for reading the illuminated target with the imager exposed for the exposure time. The controller is further operative for determining a region brightness level of a region of interest of the image when the illuminated target cannot be identified, for exposing the imager for an exposure time based on the determined region brightness level, and for reading the illuminated target with the imager exposed for the exposure time. The controller advantageously determines whether either the target brightness level or the region brightness level lies in an upper range or a lower range of brightness values and, in response, respectively reduces or increases the exposure time when the determined target brightness level or the region brightness level lies in the upper or the lower range. Advantageously, the controller is also operative for energizing the illumination system during the exposure time.

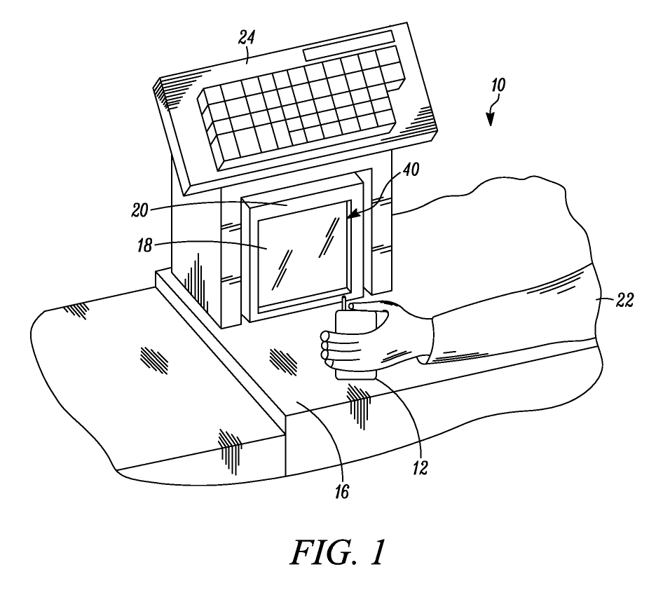

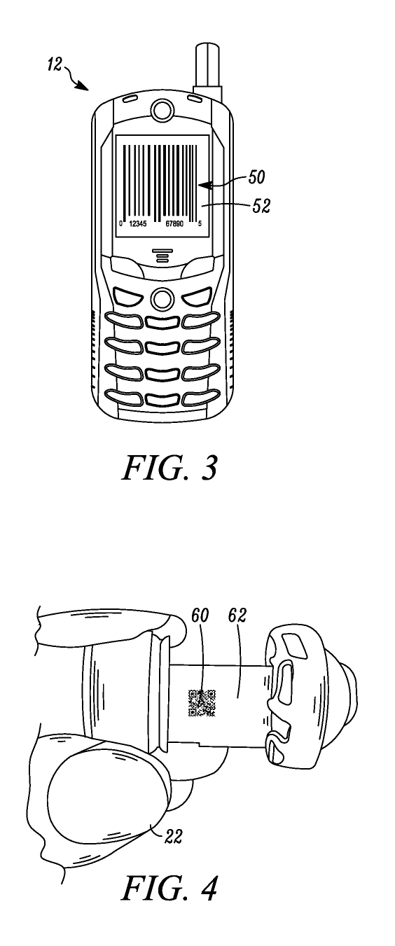

Reference numeral 10 in FIG. 1 generally identifies a workstation 10 for processing transactions at a site at which objects or products, such as a mobile electronic device 12 displaying an optical code or target 50 on a display screen 52 (see FIG. 3) or a DPM workpiece 62 marked with an optical code or target 60 (see FIG. 4), are presented to, or slid at a swipe speed past and across, a generally vertical or upright, generally planar, light-transmissive window 18 of a box-shaped housing 20 of an imaging reader 40 configured as a vertical slot scanner mounted on a countertop 16. A user 22, preferably a checkout operator or a consumer, is located at one side of the countertop 16, and the housing 20 is located at the opposite side. A cash/credit register 24 is located within easy reach of the user 22. The housing 20 is portable and lightweight and may be picked up from the countertop 16 by the user 22, and the window 18 may be aimed at the target 50, 60, preferably on a product too heavy or too large to be easily positioned on the countertop 16 in front of the housing 20 in the workstation mode.

It will be understood that the imaging reader 40 need not be implemented as the illustrated vertical slot scanner, but could also be configured as a handheld, portable scanner, a stand-mounted, stationary scanner, a flat-bed or horizontal slot scanner, or a bi-optical, dual window scanner. It will further be understood that the workstation need not be configured as the illustrated checkout counter at a retail site with the cash register 24, but that other non-retail venues without the register 24 are contemplated.

It will still further be understood that the mobile electronic device 12 need not be configured as the illustrated wireless telephone of FIG. 3 (“cell phone” or “smart phone”), but could be any mobile device capable of displaying electronic optical targets or codes, such as personal digital assistants (“PDAs”), e-readers, portable tablets, slates and computers. It will moreover be understood that the DPM workpiece 62 of FIG. 4 is merely illustrative, and that other workpieces and other codes can be marked thereon. Nor is the present invention intended to be limited solely to reading displayed targets or DPM targets, because the enhanced reading performance achieved by this invention can also apply to other targets, both symbols and non-symbols, to be optically imaged.

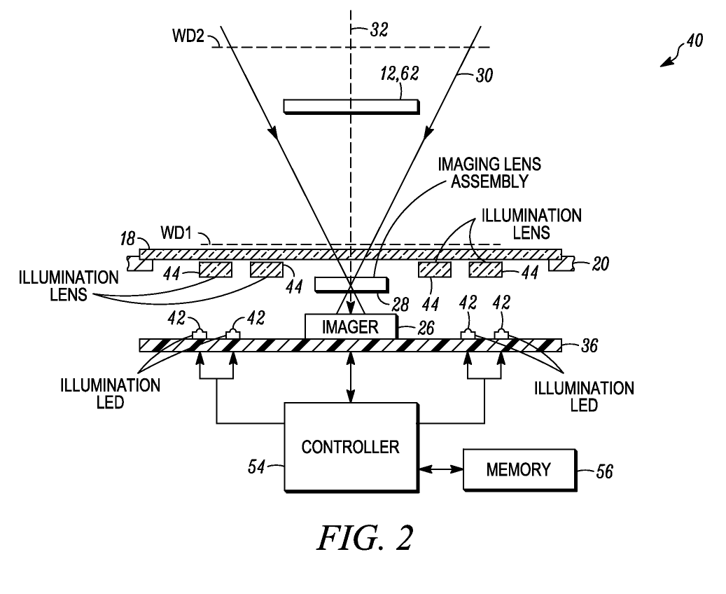

The housing 20 of the reader 40 of FIG. 1 includes, as schematically shown in FIG. 2, an image sensor or imager 26 having an adjustable exposure and mounted on a printed circuit board (PCB) 36, and an imaging lens assembly 28 mounted in front of the imager 26. The imager 26 is a solid-state device, for example, a CCD or a CMOS imager and has a linear or area array of addressable image sensors or pixels, preferably of submegapixel or supermegapixel size, having a reading field of view 30 that diverges away from the window 18 in both horizontal and vertical directions. The imaging lens assembly 28 has an optical axis 32 generally perpendicular to the imager 26 and is operative for capturing light through the window 18 from either product 12, 62 bearing, or associated with, either target 50, 60, for example, the one-dimensional UPC code 50 of FIG. 3 or the two-dimensional code 50 of FIG. 4, located in a range of working distances along the optical axis 32 between a close-in working distance (WD1) and a far-out working distance (WD2), and for projecting the captured light onto the imager 26. In a preferred embodiment, WD1 is about two inches from the imager 26 and generally coincides with the window 18, and WD2 is about eight inches or more from the window 18.

An illumination light system is also mounted in the housing 20 and preferably includes a plurality of illumination light sources, e.g., two pairs of light emitting diodes (LEDs) 42, mounted on the PCB 36 and arranged at opposite sides of the imager 26. Two pairs of illumination lenses 44 are mounted in front of the illumination LEDs 42 to uniformly illuminate the target 50, 60 with illumination light. The number of illumination LEDs 42, the number of illumination lenses 44, and their locations can be different from those illustrated in the drawings.

The imager 26 and the illumination LEDs 42 are operatively connected to a controller or programmed microprocessor 54 operative for controlling the operation of all these electrical components. A memory 56 is connected and accessible to the controller 54. The controller 54 is used for decoding light scattered from the target and for processing the captured image.

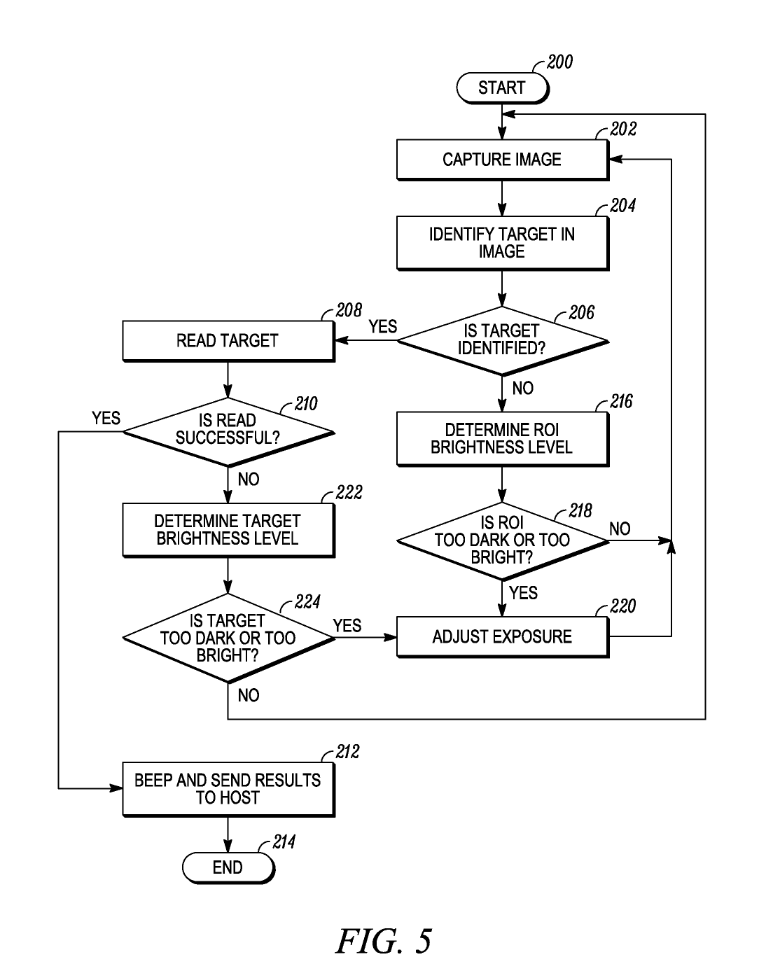

With the aid of the operational flow chart of FIG. 5, in operation, beginning at start step 200, the controller 54 captures the image of the field of view 30 at step 202. As described above, a part of the captured image contains the target, while another part of the captured image contains neighboring environmental items. By way of example, in FIG. 3, such neighboring environmental items may include parts of a hand of the operator 22 holding the electronic device 12, or remote portions of the electronic device, e.g., part of the display screen 52, or parts of the body or the controls of the electronic device 12. By way of further example, in FIG. 4, such neighboring environmental items may include parts of a hand of the operator 22 holding the workpiece 62, or remote portions of the workpiece 62 itself. In other words, the captured image contains not only the target 50, 60 that contains the useful target data to be processed, but also these and possibly other neighboring environmental items that contain non-useful data to be discarded.

As described above, if the imaging reader 40 had an auto-exposure control circuit, then such neighboring environmental items, especially when they were illuminated and reflected bright light, adversely affected the imager exposure, because the auto-exposure control circuit considered and took these brightly lit areas into account when setting the exposure. For example, if these brightly lit areas on the neighboring environmental items were very intense, then the auto-exposure control circuit would set the exposure to be too low. As a result, the optical code or target 50, 60 was often generally indiscernible from its neighboring environmental items, thereby degrading reading performance.

Hence, in accordance with one aspect of this invention, the controller 54 identifies, in step 204, at least a part of the illuminated target 50, 60 within the image. Details of how a target, such as an optical code, can be automatically identified within a captured image can be found in U.S. Pat. No. 6,250,551, the entire contents of which are hereby incorporated herein by reference thereto. If the target is successfully identified in step 206, then the controller 54 reads the target in step 208. If the target is successfully read in step 210, then the controller 54 sends the target data or results to a remote host and causes an annunciator to beep in step 212 to indicate that a successful read has been achieved, after which the reading operation ceases at end step 214.

If the target is not identified in step 206, then the controller 54 determines, in step 216, a brightness level of a region of interest (ROI) of the image. The ROI is advantageously a part, typically a central part, of the captured image, preferably containing at least a part of the illuminated target. More specifically, the controller 54 uses a histogram to measure the region brightness level at some percentile, such as between 5 and 15 percent, down from a maximum possible brightness level.

The region brightness level determined in step 216 is scaled to lie in a range of values between 0 and 255 in a typical 8-bit image. Thus, the maximum possible brightness level is the value of 255. The controller 54 determines, in step 218, whether the brightness level of the ROI lies in an upper range, e.g., between 150 to 220, or in a lower range, e.g., between 30 to 100, or in an intermediate range, e.g., between 100 to 150, of brightness values between the upper and lower ranges. If the brightness level of the ROI is not in the upper or lower ranges, then the brightness level of the ROI is in the intermediate range, and the controller 54 recaptures the image in step 202. If the brightness level of the ROI is in the upper range (“too bright”), then the controller, in step 220, reduces the exposure time, e.g., by a factor of, for example, two or more, before recapturing the image in step 202. If the brightness level of the ROI is in the lower range (“too dark”), then the controller, in step 220, increases, e.g., by a factor of, for example, two or more, the exposure time before recapturing the image in step 202.

The imaging exposure control of step 220 can be performed by adjusting the duration of the exposure of the imager 26 and/or by adjusting the duration of the illumination of the illumination LEDs 42. By way of non-limiting example, the imager 26 typically operates at a fixed frame rate (nominally about 60 frames per second with each frame lasting about 16.67 milliseconds), in which case, the nominal exposure time can be a minor fraction of the frame, e.g., less than 1 millisecond, and preferably less than 0.5 milliseconds. The illumination time generally coincides with the exposure time. Thus, if the brightness level of the ROI is too bright, then these exposure times are, for example, halved, and if the brightness level of the ROI is too dark, then these exposure times are, for example, doubled. Such increases or decreases can be performed stepwise, or gradually, and repeatedly.

If the target is not successfully read in step 210, then the controller 54 determines, in step 222, a brightness level of a background region in which at least a part of the illuminated target is located. The background region is the region around the target, i.e., the region against or in which the target is displayed, marked, or contained. Analogous to that described above, the controller 54 uses a histogram to measure a target brightness level at some percentile, such as between 5 and 15 percent, down from a maximum possible brightness level.

Also analogous to that described above, the controller 54 determines, in step 224, whether the target brightness level of the background region lies in the aforementioned upper, lower, or intermediate ranges. If the target brightness level of the background region is not in the upper or lower ranges, then the target brightness level of the background region is in the intermediate range, and the controller 54 recaptures the image in step 202. If the target brightness level of the background region is in the upper range, then the controller, in step 220, reduces the exposure time, e.g., by a factor of, for example, two or more, before recapturing the image in step 202. If the target brightness level of the background region is in the lower range, then the controller, in step 220, increases, e.g., by a factor of, for example, two or more, the exposure time before recapturing the image in step 202. The imaging exposure control of step 220 can be performed by adjusting the duration of the exposure of the imager 26 and/or by adjusting the duration of the illumination of the illumination LEDs 42. Such adjustments can be performed stepwise, or gradually, and repeatedly.

Thus, despite low or poor contrast of certain targets, the targets can still be, in accordance with this invention, successfully read fairly quickly, and the reader will have a fast, robust, aggressive performance.

It will be understood that each of the elements described above, or two or more together, also may find a useful application in other types of constructions differing from the types described above. For example, the numerical values for the upper, lower and intermediate ranges of the brightness levels of the ROI and the background region are merely exemplary and are not intended to be limiting. Also, the numerical values for the exposure times and their adjusted values are likewise merely exemplary and are not intended to be limiting.

In accordance with another feature of this invention, a method of imaging optical targets, is performed by supporting a window by a housing, illuminating an optical target with illumination light directed through the window and emitted from an energizable illumination system, capturing return illumination light as an image from a field of view extending through the window to the illuminated target and seen by an array of light sensors of a solid-state, exposable imager, processing the image to attempt reading of the illuminated target, identifying the illuminated target within the image, determining a target brightness level of a background region in which at least a part of the illuminated target is located when the illuminated target cannot be read, exposing the imager for an exposure time based on the determined target brightness level, and reading the illuminated target with the imager exposed for the exposure time.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements, but may include other elements not expressly listed or inherent to such process, method, article, or apparatus. An element proceeded by “comprises . . . a,” “has . . . a,” “includes . . . a,” or “contains . . . a,” does not, without more constraints, preclude the existence of additional identical elements in the process, method, article, or apparatus that comprises, has, includes, or contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1%, and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors, and field programmable gate arrays (FPGAs), and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein, will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. An apparatus for imaging optical targets, comprising:
a housing;
a window supported by the housing;
an energizable illumination system supported by the housing and operative for illuminating an optical target with illumination light directed through the window;
a solid-state, exposable imager supported by the housing and having an array of light sensors looking at a field of view that extends through the window to the illuminated target, and operative for capturing return illumination light from the field of view as an image; and
a controller operatively connected to the imager and the illumination system and operative for processing the image to attempt reading the illuminated target, the controller being operative for identifying the illuminated target within the image, for determining a target brightness level of a background region in which at least a part of the illuminated target is located when the illuminated target cannot be read, for exposing the imager for an exposure time based on the determined target brightness level, and for reading the illuminated target with the imager exposed for the exposure time.

2. The apparatus of claim 1, wherein the controller is also operative for energizing the illumination system during the exposure time.

3. The apparatus of claim 1, wherein the controller is operative for determining whether the target brightness level of the background region lies in an upper range of brightness values, and for reducing the exposure time when the determined target brightness level lies in the upper range.

4. The apparatus of claim 1, wherein the controller is operative for determining whether the brightness level of the background region lies in a lower range of brightness values, and for increasing the exposure time when the determined brightness level lies in the lower range.

5. The apparatus of claim 1, wherein the controller is operative for determining a region brightness level of a region of interest of the image when the illuminated target cannot be identified, for exposing the imager for an exposure time based on the determined region brightness level, and for reading the illuminated target with the imager exposed for the exposure time.

6. The apparatus of claim 1, wherein the window faces an object having a display screen on which the optical target is displayed.

7. The apparatus of claim 1, wherein the window faces an object configured as a workpiece on which the optical target is marked.

8. An apparatus for imaging optical targets on objects, comprising:
a housing;
a window supported by the housing;
an energizable illumination system supported by the housing and operative for illuminating an optical target on an object with illumination light directed through the window;
a solid-state, exposable imager supported by the housing and having an array of light sensors looking at a field of view that extends through the window to the illuminated target, and operative for capturing return illumination light from the field of view as an image; and
a controller operatively connected to the imager and the illumination system and operative for processing the image to attempt reading the illuminated target, the controller being operative for identifying the illuminated target within the image, for determining a target brightness level of a background region in which at least a part of the illuminated target is located when the illuminated target cannot be read, for exposing the imager and for energizing the illumination system for an exposure time based on the determined target brightness level, and for reading the illuminated target with the imager exposed and with the illumination system energized for the exposure time.

9. The apparatus of claim 8, wherein the controller is operative for determining whether the target brightness level of the background region lies in an upper range of brightness values, and for reducing the exposure time when the determined target brightness level lies in the upper range.

10. The apparatus of claim 8, wherein the controller is operative for determining whether the target brightness level of the background region lies in a lower range of brightness values, and for increasing the exposure time when the determined target brightness level lies in the lower range.

11. The apparatus of claim 8, wherein the controller is operative for determining a region brightness level of a region of interest of the image when the illuminated target cannot be identified, for exposing the imager and for energizing the illumination system for an exposure time based on the determined region brightness level, and for reading the illuminated target with the imager exposed and the illumination system energized for the exposure time.

12. The apparatus of claim 8, wherein the window faces the object having a display screen on which the optical target is displayed.

13. The apparatus of claim 8, wherein the window faces the object configured as a workpiece on which the optical target is marked.

14. A method of imaging optical targets, comprising:
supporting a window by a housing;
illuminating an optical target with illumination light directed through the window and emitted from an energizable illumination system;
capturing return illumination light as an image from a field of view extending through the window to the illuminated target and seen by an array of light sensors of a solid-state, exposable imager;
processing the image to attempt reading the illuminated target;
identifying the illuminated target within the image;
determining a target brightness level of a background region in which at least a part of the illuminated target is located when the illuminated target cannot be read;
exposing the imager for an exposure time based on the determined target brightness level; and
reading the illuminated target with the imager exposed for the exposure time.

15. The method of claim 14, and energizing the illumination system during the exposure time.

16. The method of claim 14, wherein the determining is performed by determining whether the target brightness level of the background region lies in an upper range of brightness values, and by reducing the exposure time when the determined target brightness level lies in the upper range.

17. The method of claim 14, wherein the determining is performed by determining whether the target brightness level of the background region lies in a lower range of brightness values, and by increasing the exposure time when the determined target brightness level lies in the lower range.

18. The method of claim 14, and determining a region brightness level of a region of interest of the image when the illuminated target cannot be identified, and exposing the imager for an exposure time based on the determined region brightness level, and reading the illuminated target with the imager exposed for the exposure time.

19. The method of claim 14, and providing the optical target on an object, and facing the object bearing the optical target to the window, and configuring the object with a display screen, and displaying the optical target on the display screen.

20. The method of claim 14, and providing the optical target on an object, and facing the object bearing the optical target to the window, and configuring the object as a workpiece, and marking the optical target on the workpiece.
